(19) United States
(12) Patent Application Publication
(10) Pub. No.: US 2004/0067809 A1
(43) Pub. Date: Apr. 8, 2004

(54) Actuating device for a vehicle steering system

(76) Inventors: Juergen Hoersch, Gschwend (DE); Michael-Horst Geiser, Gmuend (DE)

Correspondence Address: Jordan & Hamburg, 122 East 42nd Street, New York, NY, 10168, US

(21) Appl. No.: 10/467,424

(22) PCT Filed: Apr. 10, 2002
(86) PCT No.: PCT/EP02/03967

(30) Foreign Application Priority Data
Apr. 14, 2001 (DE) 101 18 663.0

(51) Int. Cl. F16H 3/72

(52) U.S. Cl. 475/4

(57) ABSTRACT

The invention relates to an actuating device for a vehicle steering system, said actuating device being designed as an epicyclic gear (1), in which is arranged a stepped planet (2) or are arranged a plurality of stepped planets (2), of which in each case two interconnected planet wheels (4 and 5) are in constant engagement with other gear wheels (11 and 12) of the epicyclic gear (1), pivotably mounted levers (8) acted upon by force by means of springs being integrated in or on the carrier plates (7) of the planet carrier (6) and having bearings (21) for receiving the journals (13) of a stepped planet (2), the planet axes of the stepped planets (2) mounted in the levers (8) being displaceable approximately radially.

The invention relates to an actuating device for a vehicle steering system, according to the preamble of patent claim 1.

Actuating devices for vehicle steering systems, which serve for the superposed rotary-angle transmission of two gear inputs, are known. While one gear input is acted upon by a steering handwheel and the other by a motor, the gear output is connected to the steering gear. The actuating device is designed as an epicyclic gear which consists of a stepped planet which is held in the planet carrier and the planet wheels of which are in each case connected rigidly to one another and are in constant toothed engagement with two sun wheels, one of which is connected to the first gear input, while the other is assigned to the gear output. A worm operatively connected to the motor and meshing with a worm wheel connected to the planet carrier serves as a second gear input.

In toothed gears, and also in actuated devices operated by means of gearwheels, production-induced tolerances, such as tooth thickness variations, flank shape errors, true running errors, pitch errors and center distance deviations, occur. In order to avoid a jamming of the gearwheels, there must therefore always be play present between the flanks. This tooth flank play is disturbing in applications such as the actuating device for vehicle steering systems, since, there, freedom from play in both directions of rotation is necessary up to a defined torque.

An epicyclic gear with means for eliminating the disturbing tooth flank play is described in DE 197 57 433 A1. This epicyclic gear has a ring wheel, a pinion and a planet carrier with planet wheels meshing simultaneously in the ring wheel and the pinion. The ring wheel and the pinion are an inch greater in terms of their width than the width of the planet wheel which is in engagement with them. This excess width is in each case assigned to the meshing planet wheel in such a way that it projects in each case on one side of the planet wheel. In this case, the pinion projects beyond an end face of the planet wheel which is located opposite that on which the excess width of the ring wheel projects beyond the planet wheel. Mounted on the two end faces of the planet wheel is an additional gear wheel which is rotatable coaxially with the planet wheel and which in each case is braced in a tortionally elastic manner with respect to the planet wheel. By virtue of the tooth width design described above, it is possible that, of the additional gear wheels, one is in toothed engagement only with the pinion and the other only with the ring wheel, so that one additional gear wheel acts as an additional gear wheel tensioning radially on the inside, while the other acts as an additional gear wheel tensioning radially on the outside.

This solution requires a relatively high outlay in structural terms with regard to the special additional gearwheels and their arrangement in relation to the tooth width design of the pinion and ring wheel of the epicyclic gear.

Furthermore, epicyclic gears are known in which at least the bearing journals of a stepped planet are guided radially moveably in long holes and are braced relative to the sun wheels by means of bow springs. The stepped planets guided in this way have, for the desired radial moveability in the long holes, a play which influences the tangential rigidity, and the bow springs which are in interaction with these long holes are inclined to spread the springing force which, moreover, over the useful life of the bow springs, is reduced owing to spring fatigue. Furthermore, the additional guide elements of the bearing journals in the long holes restrict the available amount of space required.

The solution specified in patent claim 1 is based on the problem of designing a play-free epicyclic gear of the type initially specified, in which freedom from play is implemented by operationally reliable and structurally simple means, with high tangential rigidity and high long-term stability, along with a defined prestressing force. The problem is solved by means of the features listed in the characterizing part of patent claim 1, in that the mounting of the stepped-planet journals of at least one stepped planet of the epicyclic gear takes place in pivotably arranged levers and the planet wheels are displaced approximately radially by means of spring force.

The advantages achieved by means of the invention are, in particular, that the elastic lever arm provides a means of small build for play compensation, in which manufacturing tolerances and tooth flank play are negligible, despite the fact that a long useful life can be achieved.

Advantageous developments of the invention are specified in the dependent claims.

An exemplary embodiment of the invention is illustrated in the drawing and is explained in more detail below. In the drawing:

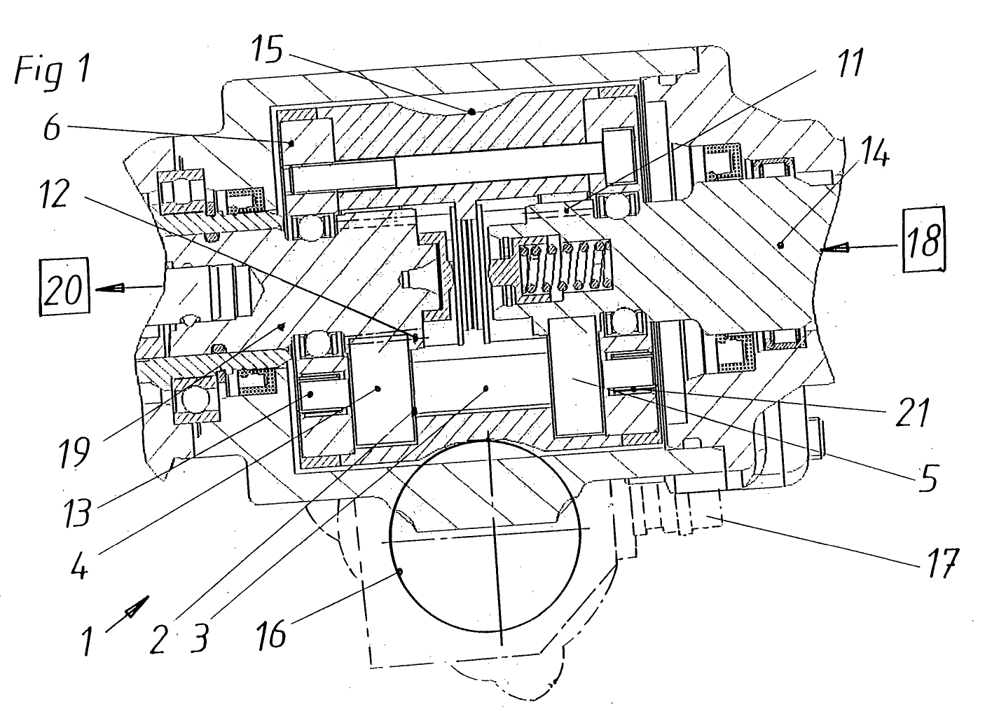

FIG. 1 shows a play-free epicyclic gear as an actuating device for a vehicle steering system in longitudinal section.

FIG. 2 shows a carrier plate of a planet carrier with a lever mounting for a stepped planet;

FIG. 3 shows a section A-A according to FIG. 2.

Essentially identical parts in the various figures are given the same reference symbols.

The drawing illustrates an epicyclic gear 1 with a plurality of stepped planets 2 as an actuating device for a vehicle steering system. As can be seen from FIG. 1, these stepped planets 2 are held in a carrier plate 7 of the planet carrier 6 by means of rolling bearings 21 and in each case have two planet wheels 4 and 5 which are connected rigidly in pairs by means of a shaft 3. The planet wheels 4 and 5 of the stepped planets 2 are in constant toothed engagement with two sun wheels 11 and 12. The gear input 14 acting via the steering handwheel 18 is connected to the first sun wheel 11, while the second sun wheel 12 is assigned to the gear output 19. The second gear input 15 and 16, here designed as a worm 15 and worm wheel 16, is activated via a servomotor 17. The steering handwheel 18 and the steering gear 20 are illustrated merely symbolically as blocks.

As shown in FIGS. 2 and 3, in the two carrier plates 7 of the planet carrier 6, levers 8 are arranged, which, on the one hand, are mounted in a play-free manner in the carrier plates 7 by means of prestressed rolling bodies 10 and are acted upon with force via springs 9 and, on the other hand, have bearings 21 for receiving the journals 13 of a stepped planet 2. The levers 8 are arranged in the carrier plates 7 of the planet carrier 6 in such a way that their deflection takes place virtually at right angles to the connecting line between the center of rotation of the lever 8 and the center of rotation of the stepped planet 2, with the result that the planet axis of the stepped planet 2 mounted in the bearings 21 is displaceable approximately radially. Each lever 8 is designed as a one-sided or two-sided lever 8, that is to say the mounting 21 of the respective stepped-planet journal 13 and the spring 9 are arranged on one side at a distance from the mounting 10 of the lever 8 or this mounting 10 is located between the point of action of the spring 8 and the mounting 21 of the stepped planet 2. The spring 9 acting with force upon the lever 8 is supported on the cover closing the epicyclic gear 1. On the other hand, it is also possible for the spring 9 to be supported on the prolonging centering collar of the worm wheel 16 or on the housing of the planet carrier 6 or on other components connected to this. Depending on the design of the lever 8, the spring located at a distance from the bearing 10 is designed so as to be subjected to pressure or to tension, but it is the possibility of installing a spring 9 acting as a tortion spring directly at the center of rotation of the lever 8. The spring-loaded levers 8 integrated on both sides of the stepped planet 2 act on this stepped planet 2 in such a way that its planet wheels 4 and 5 come to bear, in their ideal geometric position, against the sun wheels.

Instead of only one stepped planet 2 being acted upon by a radially active force via prestressed levers 8, a plurality of or all the stepped planets 2 of the actuating device may also be equipped with lever-mounted journals 13 of this type.

In functional terms, in this acting device for a vehicle steering system, the rotary angle introduced into the steering handwheel 18 by the driver is introduced via the first gear input 14 and the sun wheel 11. A gear output 19 connected fixedly in terms of rotation to the second sun wheel 12 is connected to the steerable vehicle wheels via the steering gear 20. A regulating unit, not illustrated, which, via sensors, detects the adjustment of the steering angle and, if appropriate, other characteristic values influencing the steering characteristic, activates the servomotor 17 which acts on the second gear input 15 and 16 and consequently on the planet carrier 6. The transmission ratio between the gear input 14 and the gear output 19 is determined, then, by the direction of rotation and the rotational speed of the servomotor 17 by the rotary angle introduced via the steering handwheel 18 being superposed.

An epicyclic gear 1 with the functionality described may also be designed in such a way that the planet wheels 4 and 5 of the stepped planet 2 engage into two ring wheels or into one ring wheel and one sun wheel 11 or 12. The functional principle may likewise be applied to composite epicyclic gears 1.

This epicyclic gear 1 described may also be designed without a second gear input 15 and 16. In this case, depending on the type of gear stepping, the stepped planets 2 make it possible to reduce or increase an input rotational speed in both directions of rotation in a play-free manner and with low-noise running. This version makes it possible for the epicyclic gear 1 to have an application in all sectors of mechanical engineering and vehicle construction in which stepped-down and stepped-up rotational speeds are required.

1. An actuating device for a vehicle steering system, with the following features:
a stepped planet or a plurality of stepped planets is or are arranged in an epicyclic gear serving as an actuating device for a vehicle steering systems,
the in each case two interconnected planet wheels of the stepped planet or stepped planets are in constant engagement with other gear wheels of the epicyclic gear,
the other gear wheels of the epicyclic gear are equipped with internal or external toothing, characterized by the following features:
pivotably mounted levers (8) acted upon with force by means of springs (9) are integrated in or on the carrier plates (7) of the planet carrier (6),
the levers (8) have bearings (21) for receiving the journals (13) of a stepped planet (2).

2. The actuating device for a vehicle steering system as claimed in claim 1, characterized in that the mounting (10) of the levers (8) takes place in a play-free manner in or on the carrier plates (7) by means of prestressed rolling bodies.

3. The actuating device for a vehicle steering system as claimed in claim 1 or 2, characterized in that the levers (8) are arranged in such a way that their deflection takes place virtually at right angles to the connecting line between the center of rotation of the lever (8) and the center of rotation of the stepped planet (2), with the result that the planet axes of the stepped planets (2) mounted in the levers (8) are displaceable approximately radially.

4. The actuating device for a vehicle steering system as claimed in one of claims 1 to 3, characterized in that the spring (9), which is in each case acting with force upon the lever (8), is supported on the housing of the planet carrier (7) or on other components connected fixedly to this.

5. The actuating device for a vehicle steering system as claimed in one of claims 1 to 4, characterized in that the lever or levers (8) is or are designed as a one-sided or two-sided lever (8).

6. The actuating device for a vehicle steering system as claimed in one of claims 1 to 5, characterized in that each lever (8) is acted upon with force by means of a tortion spring integrated in the bearing (10).
